(19) United States
(12) Patent Application Publication
(10) Pub. No.: US 2009/0280686 A1
(43) Pub. Date: Nov. 12, 2009

(54) ELECTRICAL CONNECTOR

(76) Inventors: Taizo SOGO, Tokyo (JP); Takayuki ARAI, Tokyo (JP); Takeshi SATO, Tokyo (JP); Taku KAWANO, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/436,919

(22) Filed: May 7, 2009

(30) Foreign Application Priority Data
May 8, 2008 (JP) 2008-122132

(51) Int. Cl. H01R 9/03

(52) U.S. Cl. 439/607.52

(57) ABSTRACT

An electrical connector having a contact connection portion electrically shielded better than heretofore. The connector is reduced in size and cost. The connector has contacts connected with a signal line, an insulative housing, and a metal shell surrounding and electrically shielding the housing except for a connection portion that is a region necessary for connection with a mating member. The housing has accommodation portions for receiving the contacts. A part of the metal shell has a shielding wall surface surrounding the entire outer periphery of a peripheral wall forming the connection portion of the housing with a given gap therebetween. The four sides of the shielding wall surface have lock portions by which the receptacle connector of the mating member is engaged and anchored.

### BACKGROUND OF THE INVENTION

1. Field of the Invention

The present invention relates to an electrical connector having a shell that electrically shields the junctions between contacts.

2. Prior Art

In one conventional electrical connector, an electrical shielding structure is formed on one surface of the connecting portion of an insulative housing as shown in FIGS. 6A and 6B. In another conventional electrical connector, electrical shielding structures are formed on both surfaces of an insulative housing of an electrical connector 23 as shown in FIGS. 7A and 7B. Locking mechanisms for these structures operating during an operation for achieving a fitting engagement are fabricated independent of electrically shielding shells. A known electrical connector of this type is described in JPA-2000215948.

However, in such conventional electrical connectors, the portions that electrically shield the junctions between contacts are small in number. For example, the shielding portion is formed only one surface or there are only two shielding portions. Therefore, in order to intensify the shielding effect, it is necessary to increase the number of shielding portions or shielding members. In addition, the locking mechanism is fabricated independently. This increases the number of components and the number of assembly steps. Consequently, there is a problem that the cost is high.

### SUMMARY OF THE INVENTION

The present invention is intended to solve the foregoing problems with the prior art. It is an object of the invention to provide an electrical connector that permits a contact connection portion to be electrically shielded better than heretofore and which can achieve reductions in size and cost.

An electrical connector according to the present invention includes contacts connected with a signal line, an insulative housing having accommodation portions for receiving the contacts, and a metal shell for surrounding and electrically shielding the housing except for a connection portion that is a region necessary for connection with a mating member. A part of the metal shell has a shielding wall surface that surrounds the entire outer periphery of a peripheral wall forming the connection portion of the housing such that a given space is left between the shielding wall surface and the peripheral wall. Each of four sides of the shielding wall surface has a locking portion that engages and anchors the receptacle connector of the mating member.

Preferably, the locking portion is a protrusive portion projecting inward from the shielding wall surface. The locking portion is engaged in a recessed portion formed in the surface of the metal shell of the receptacle connector of the mating member.

An electrical connector of the present invention has a connection portion connected with a mating member that makes fitting engagement with the electrical connector. The entire outer periphery of the insulative housing forming the connection portion of the connector is surrounded by the metal shell. Therefore, the contact junctions cooperate with the shell of the mating member to provide double shielding. Thus, the shielding performance is improved. The locking portion is formed integrally with the portion of the shell that surrounds the connection portion. Consequently, miniaturization is achieved without increasing the number of components. Furthermore, the cost is reduced.

### BRIEF DESCRIPTION OF THE DRAWINGS

FIGS. 1A, 1B, and 1C are a side elevation view, a bottom view, and a front elevation view, respectively, of an electrical connector according to an embodiment of the present invention;

FIG. 2A is a perspective view of the electrical connector, and in which the shell is not yet assembled;

FIG. 2B is a side elevation view of the electrical connector, and in which the shell has been assembled;

FIGS. 3A and 3B are a side elevation view and a vertical cross section view, respectively, of the receptacle connector of a mating member that makes fitting engagement with the electrical connector;

FIG. 4 is a side elevation view partly in cutaway of the electrical connector, illustrating its state of usage;

FIG. 5 is a front elevation view partly in cutaway of the electrical connector, illustrating its state of usage;

FIGS. 6A and 6B are a plan view and a side elevation view in vertical cross section, respectively, of an electrical connector according to a prior-art example, showing the manner in which the connector is in fitting engagement; and

FIGS. 7A and 7B are a plan view and a side elevation view in vertical cross section, respectively, of an electrical connector according to another prior-art example, showing the manner in which the connector is in fitting engagement.

### DETAILED DESCRIPTION OF THE PREFERRED EMBODIMENTS

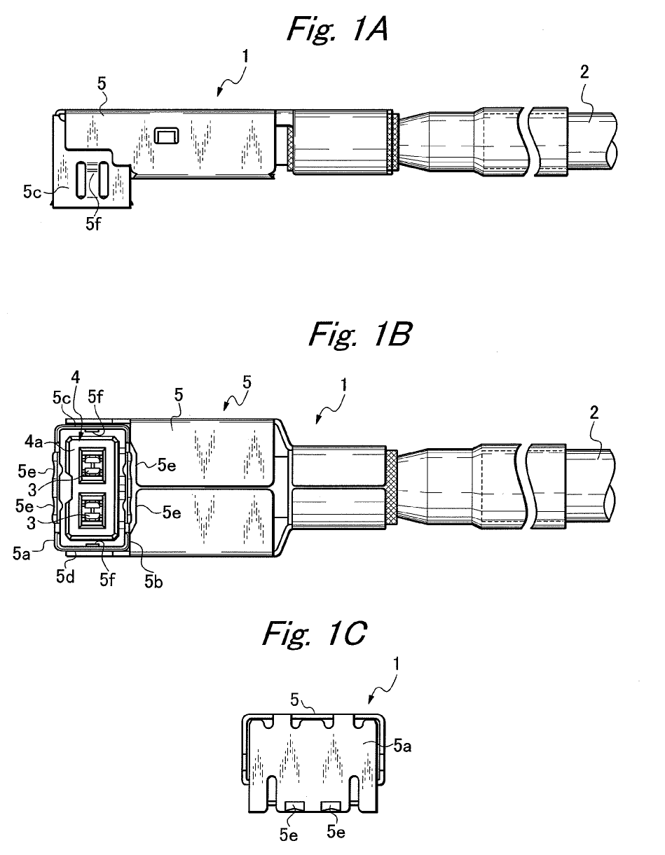

As shown in FIGS. 1A-1C, an electrical connector 1 according to an embodiment of the present invention includes contacts 3 connected with a signal line 2 having mesh wire, an insulative housing 4 having accommodation portions for receiving the contacts 3, and a metal shell 5 for surrounding and electrically shielding the housing 4 except for a connection portion 4a that is a region necessary for connection with a mating member.

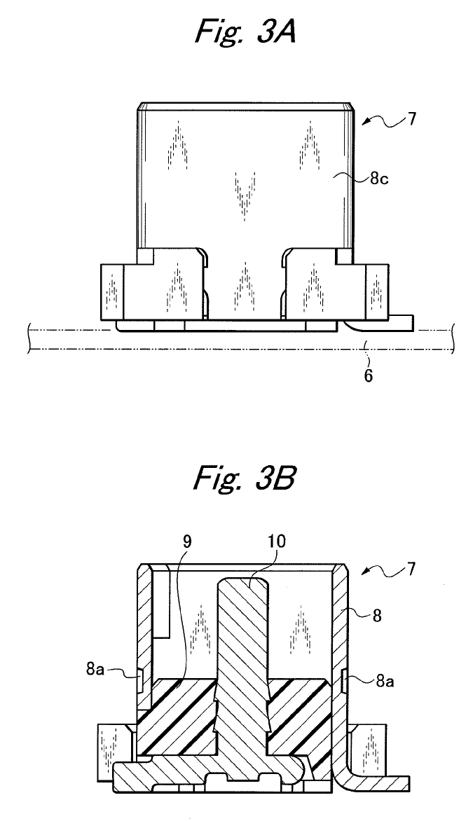

The electrical connector 1 is low in height and connected with a receptacle connector 7 mounted on a printed circuit board 6 shown in FIG. 3. The connector 1 is fitted in a direction perpendicular to the longitudinal direction of the signal line 2.

As shown in FIG. 1B, a part of the metal shell 5 forms a shielding wall surface, 5a-5d, surrounding the entire outer periphery of a peripheral wall forming a rectangular connection portion 4a with a given gap therebetween in the housing 4. Lock portions 5e and 5f are formed in the four sides 5a-5d of the shielding wall surface.

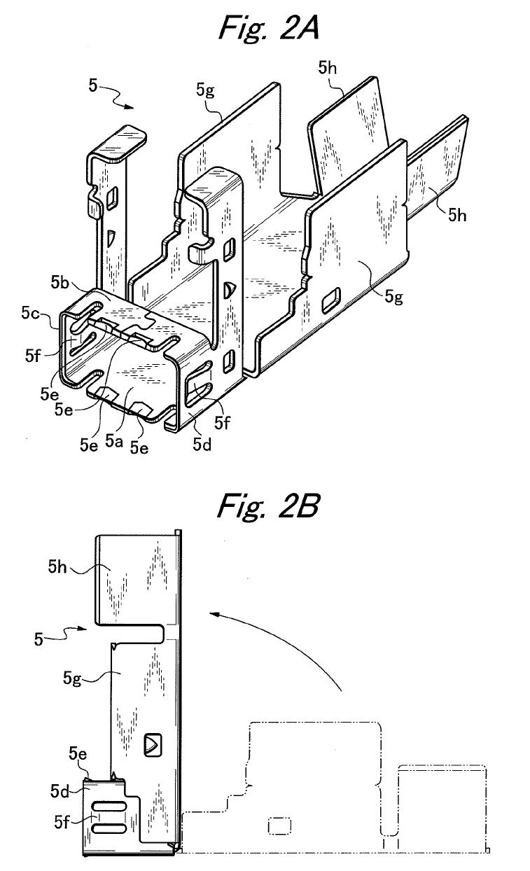

FIG. 2A shows the metal shell 5 in a state obtained before the housing 4 and cable 2 are mounted and machined. FIG. 2B shows a state obtained before execution of a sequence of operations consisting of mounting the housing 4 to the metal shell 5, mounting the cable 2 to the housing via connectors 3, then crimping crimped portions 5g against the housing 4 when the shell has been bent through 90 degrees such that the housing is covered, and crimping other crimped portions 5h against the cable 2 to cover the cable. The connection portion 4a of the housing 4 is fitted over the shielding wall surface, 5a-5d.

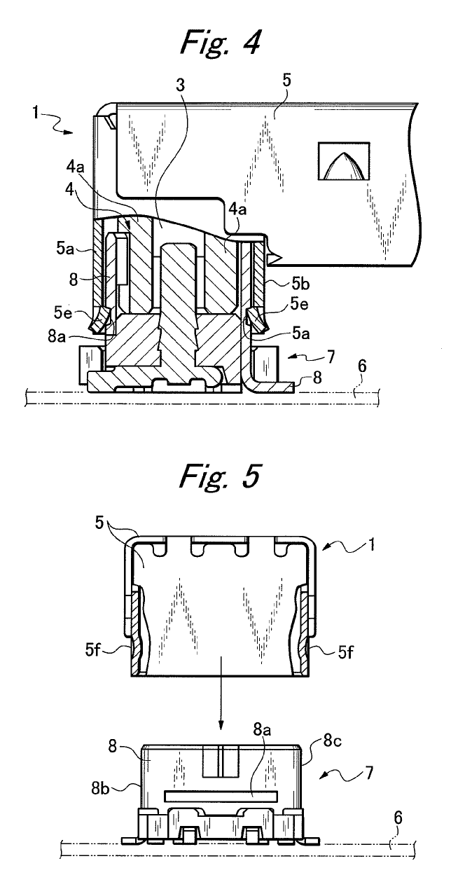

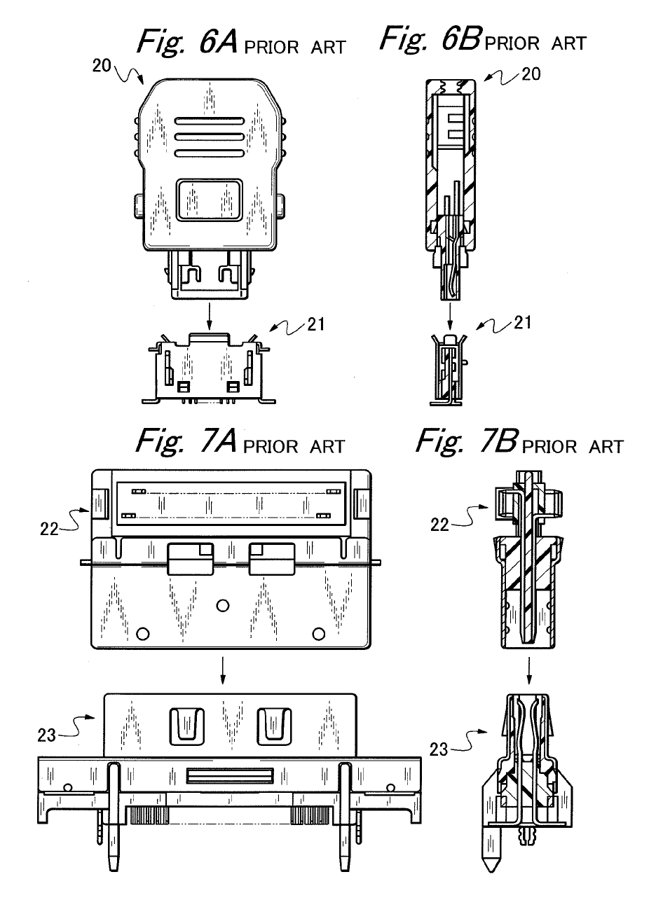

The lock portions 5e and 5f are protrusive portions projecting inward from the shielding wall surface 5a-5d. The lock portions are engaged in a recessed portion 8a (see FIG. 4) fabricated by inwardly recessing the surface of the metal shell 8 surrounding the outer periphery of a housing 9 and a contact 10 of the receptacle connector 7 of the mating member as shown in FIGS. 3A and 3B. The recessed portion 8a assumes this form to prevent the shielding effect from decreasing.

As shown in FIGS. 4 and 5, if the electrical connector 1 is fitted to the receptacle connector 7 surface-mounted on the printed circuit board 6, the shielding wall surface 5a-5d of the metal shell 5 surrounds and electrically shield the entire outer periphery of the shell 8 of the rectangular receptacle connector 7. The lock portions 5e and 5f bring their protrusive portions into engagement with the recessed portion 8a. As shown in FIG. 5, the lock portions 5f are brought into strong sliding contact with peripheral wall portions 8b and 8c of the mating metal shell 8, thus assisting the locking.

In this way, the electrical connector 1 according to the present invention enhances the shielding effect by surrounding the entire outer periphery of a rectangular peripheral wall by a metal shell at the junctions between contacts. A locking mechanism is mounted on the peripheral wall. Therefore, the cost can be reduced without increasing the number of components.

What is claimed is:

1. An electrical connector comprising:
contacts connected with a signal line;
an insulative housing having accommodation portions in which the contacts are received; and
a metal shell surrounding and electrically shielding the housing except for a connection portion that is a region necessary for connection with a mating member;
wherein a part of the metal shell has a shielding wall surface surrounding the entire outer periphery of a peripheral wall forming a connection portion of the housing such that a given gap is left therebetween; and
wherein four sides of the shielding wall surface have lock portions by which a receptacle connector of the mating member is engaged and anchored.

2. An electrical connector according to claim 1, wherein said lock portions are protrusive portions projecting inward from the shielding wall surface and engage a recessed portion formed in a surface of the metal shell of the receptacle connector of the mating member.
